(19) United States
(12) Patent Application Publication
(10) Pub. No.: US 2018/0104149 A1
(43) Pub. Date: Apr. 19, 2018

(54) CONTAINMENT AND TRANSFER DEVICE FOR HIGHLY ACTIVE OR SENSITIVE COMPOUNDS

(71) Applicants: Leonard A. NOWAK, Whitehouse Station, NJ (US); Merck Sharp & Dohme Corp., Rahway, NJ (US)

(72) Inventor: LEONARD A. NOWAK, TUMACACORI, AZ (US)

(73) Assignee: Merck Sharp & Dohme Corp., Rahway, NJ (US)

(21) Appl. No.: 15/559,963

(22) PCT Filed: Mar. 15, 2016
(86) PCT No.: PCT/US2016/022403

§ 371 Date: Sep. 20, 2017

Related U.S. Application Data
(60) Provisional application No. 62/135,928, filed on Mar. 20, 2015.

(51) Int. Cl. A61J 1/20; A61J 1/14; A61J 1/10; F16K 7/06; F16L 23/036; F16L 55/115; F16B 2/06; F16B 2/10

(52) U.S. Cl. CPC A61J 1/2048; A61J 1/1412; A61J 1/1468; A61J 1/1475; A61J 1/10; F16L 2201/44; F16L 23/036; F16L 55/115; F16B 2/065; F16B 2/10; F16K 7/06

(57) ABSTRACT

A containment and transfer device for use with highly active or sensitive compounds, comprising a sleeve or a bag with one or more flexible walls, a first sanitary clamp, an endcap, a second sanitary clamp and a compression clamp. The sleeve or bag has a first end for connection to a container, and a second end for (a) connection to a storage or mixing vessel at the discharge location, or (b) connection to an endcap for transportation. The flexible walls surround and define an internal passageway in that permits compounds in the first end of the sleeve or bag to pass into the second end of the sleeve or bag. The compression clamp compresses the flexible walls of the sleeve or bag together to produce a barrier across the internal passageway, preventing the highly active or sensitive compound from flowing into the second end of the sleeve or bag during packing, transporting and discharging the device.

### FIELD OF THE INVENTION

The present invention relates generally to the field of containment and transfer devices, and more particularly to containment and transfer devices for handling, shipping and storing highly active or sensitive compounds.

### RELATED ART

There are a number of serious potential problems associated with packing, storing, transporting and discharging and rinsing containers filled with highly active and/or sensitive compounds. These problems may include, for example, microbial ingress and leaking caused by ruptures or deformations resulting from accidental impact or dramatic fluctuations in altitude, pressure and temperature when the containers are transported over large distances by air and ground transportation. Other potential problems include exposing personnel to hazardous substances and contaminating working environments when the containers are opened for filling, rinsing and discharging operations. In addition, the highly active or sensitive compound is sometimes contaminated or degraded as a result of accidental contact with personnel and/or other substances in those working environments. Therefore, when such containers with highly active or sensitive compounds are handled and transported, extreme care must be taken at every stage of the process in order to protect personnel, environments and property from dangerous exposures and potentially life-threatening situations.

Typically, dedicated isolation equipment, used in combination with protective clothing and anticontamination procedures, must be employed whenever containers with highly active or sensitive compounds are handled, and particularly when the handling involves opening the containers and transferring their contents to other vessels, such as other storage, mixing and holding tanks, or pipes and conduits associated with such tanks. It has been found, however, that many of the conventional dedicated isolation systems, as well as many of the conventional manual anticontamination procedures, are difficult to use, cumbersome, expensive and time-consuming. More importantly, many of the conventional devices and techniques, despite their expense and implementation difficulties, still fail to provide adequate levels of protection under certain circumstances.

For example, it is common in the pharmaceutical industry to place highly active or sensitive compounds inside bottles having threaded openings. After filling these bottles with the highly active or sensitive compound at the filling location, the bottles are closed by screwing on a threaded cap. The closed bottles are then placed inside a bag (overwrapped) and shipped to a user site, where a human operator wearing gloves and/or other protective clothing removes the bottle from the bag, unscrews the cap to open the bottle, and then attaches some kind of connecting apparatus (such as a bib, tube or hose with a threaded collar) to the threaded opening on the bottle so that the bottle can be overturned and the bottle's contents can be emptied into another vessel, such as a mixing or storage tank. Unfortunately, when this procedure is used, there is a very high potential for contaminating the working environment, possibly exposing the human operator and coworkers to a dangerous substance and/or contaminating the compound. If the highly active or sensitive compound is a powder, for instance, then particles of the powder are likely to get caught on the threads of the bottle, the threads of the cap, or the threads of both the bottle and cap, when the bottle is filled, transported and/or opened. Particles of the compound are also likely to stick to the underside of the cap. If there is vertical laminar flow in the area where the bottle is opened to perform the transfer operation, then the vertical laminar flow may cause additional particles to escape the bottle and be dispersed into the air and/or spread around on nearby surfaces within the working area. In some situations, standard procedure may require rinsing the bottle after the compound is removed, which means the system has to be opened again solely for the purpose of introducing a rinsing solution, thus further exposing the hazardous compound to the environment or further exposing personnel to the hazardous compound.

When removing the compound from the bottle requires opening the bottle and temporarily exposing the environment and nearby personnel to the compound, or exposing the compound to the environment, while the conduit to the next mixing or storage vessel is attached, such systems are considered “semi-closed” containment and transfer systems. Semi-closed containment and transfer systems are considered inferior to closed containment and transfer systems.

Accordingly, there is considerable need in the art for a closed containment and transfer system for use with containers of highly active and sensitive compounds, in both sterile and non-sterile environments, which eliminates the risks of accidental exposures and contamination arising from semi-closed containment and transfer systems. There is a further need in the art for a containment and transfer system that maintains its integrity while the containers undergo extreme fluctuations in altitude, pressure and temperature associated with air and ground transportation over large distances.

### SUMMARY OF THE INVENTION

In general, embodiments of the present invention address the above-described needs by providing a containment and transfer device for use with containers of highly active or sensitive compounds, such as active pharmaceutical agents, dioxin, led, heavy metal substances or lyophilized vaccines, to name a few examples. The containment and transfer device includes a sleeve, a first sanitary clamp, an endcap, a second sanitary clamp and a compression clamp. The sleeve has a first end for connection to the container, and a second end for connection to the endcap during packing and transportation, and connection to a storage or mixing vessel at the discharge location. The sleeve also includes one or more flexible walls surrounding and defining an internal passageway fluidly coupling the first end of the sleeve to the second end of the sleeve. The first sanitary clamp is configured to fasten the first end of the sleeve to a sanitary fitting on the mouth of the container. The second sanitary clamp is configured to fasten the second end of the sleeve to the endcap, which is adapted to shut the second end of the sleeve, or to the storage or mixing vessel at the discharge location. Thus, the second sanitary clamp and the endcap cooperate to close and completely seal off the second end of the sleeve, and maintain this seal the entire time that the container and the containment system are being transported and/or stored. The compression clamp is releasably attached to an intermediate section of the sleeve, so that the jaws of the compression clamp will compress the flexible walls of the sleeve together in a uniform fashion to produce a barrier across the internal passageway, effectively closing down and sealing off the internal passageway.

In one embodiment, the barrier across the internal passageway forms a hermetic seal that will not permit any portion of the highly active or sensitive compound to pass from the first end of the sleeve into the second end of the sleeve. Thus, the second end of the sleeve remains free of the highly active or sensitive compound—despite significant changes in altitude, temperature or pressure outside of the device. In other embodiments of the invention, where, for example, a small amount of leaking can be tolerated, the compression clamp and the resulting barrier may be configured to eliminate the migration of all but an extremely small amount of the compound from the first end of the sleeve to the second end of the sleeve, so long as the amount of the compound permitted to migrate across the barrier does not exceed a specified maximum rate or volume. The maximum rate or volume of migration across the barrier (which indicates the efficacy of the seal) may be determined and expressed in a variety of different ways. One useful way of determining and expressing the maximum migration rate, for instance, is to measure the rate at which a small molecule gas, such as helium, passes through the seal. Thus, in a preferred embodiment of the present invention, the barrier across the internal passageway will permit helium to pass from the first end of the sleeve to the second end of the sleeve at a rate that is not greater than 1.0×10⁻³ cc/sec. In a more preferred embodiment, the rate of migration of helium across the barrier is not greater than 1.0×10⁻⁴ cc/sec. In a most preferred embodiment, rate of the migration of helium across the barrier is not greater than 1.0×10⁻⁵ cc/sec.

In other words, due to the presence of the barrier across the internal passageway of the sleeve, all or substantially all, of the highly active or sensitive compound put into the container at the filling location will remain in the container and the first end of the sleeve while the container and the attached containment and transfer device are packed and transported to the user site. None of the compound (or, alternatively, only an acceptably small amount of the compound) will be permitted to pass into the second end of the sleeve. When the container and containment and transfer system reach their final destination at the user site, the second sanitary clamp and the endcap are removed so that the second end of the sleeve can be attached to another vessel, such as a storage or mixing tank. Once that connection is made, the compression clamp attached to the intermediate section of the sleeve is removed, thereby removing the barrier across the internal passageway, and permitting the highly active or sensitive compound located in the container and in the first end of the sleeve to pass through the internal passageway, through the second end of the sleeve and into the storage or mixing tank. The containment and transfer device of the present invention is considered a closed system because the container and the first end of the sleeve are never opened to the working environment during the discharging operation.

The compression clamp has at least one pair of jaws, wherein each jaw is configured to cooperate with the other jaws to apply uniaxial compression forces to the outward-facing surfaces of the flexible walls of the sleeve. Preferably, the magnitudes of the uniaxial compression forces applied to the outward-facing surfaces of the flexible walls are substantially uniform across the entire bite-length of the pair of jaws in the compression clamp. The uniformity in the magnitudes of the compression forces improves the integrity of the seal created by the barrier, especially when the highly active or sensitive compound has very small molecules. The compression clamp further includes at least one threaded rod configured to hold each jaw in the pair of jaws in an opposing orientation to the other jaw, and at least one nut operable with the at least one threaded rod to uniformly adjust the magnitudes of the uniaxial compression forces applied to the one or more flexible walls of the sleeve.

Ideally, the compression clamp will have a pair of threaded rods (or bolts) and a corresponding pair of threaded nuts; although the compression clamp may also have fewer and greater numbers of corresponding rods and nuts, as well as multiple pairs of jaws, without departing from the scope of the invention. Preferably, each nut in the pair of nuts on the compression clamp is tightened until the applied torque on the nut measures in the range of about 5 to about 65 inch-pounds (about 0.5649 to about 7.344 newton meters). More preferably, each nut in the pair of nuts is tightened until the applied torque on the nut is in the range of about 20 to about 50 inch-pounds (about 2.26 to about 5.649 newton meters). Most preferably, each nut in the pair of nuts is tightened until the applied torque on the nut is about 35 inch-pounds (about 3.954 newton meters). It will be appreciated, however, that instead of tightening the nuts to these torque settings, embodiments of the present invention may instead call for configuring the compression clamp so that the nuts are locked into position and will not rotate, while the desired torque is applied to the threaded rods extended through the nuts. The torque applied to the nuts, the threaded rods, or both the nuts and the threaded rods, may be measured with a standard torque wrench as is well known in the art.

The compression clamp may be constructed from any rigid material, such as hardened plastic, or metal (e.g., stainless steel). Ideally, the inward-facing surfaces on each jaw in the pair of jaws on the compression clamp has a semi cylindrical shape, so that the points of contact between the inward-facing surfaces of the jaws on the compression clamp and the outward-facing surfaces of flexible walls on the sleeve form a hard and narrow line across the sleeve, thereby creating a “pinch” on the internal passageway that is more concentrated, which improves the strength and integrity of the barrier.

The sleeve may be constructed from an elastomeric material, such as silicone rubber. In some implementations, the sleeve is substantially cylindrical in shape, which means that the cross section of the sleeve in its uncompressed state is substantially a circle (or an ellipse). In this case, the sleeve may have only one continuous, cylindrically shaped, and flexible wall surrounding and defining the internal passageway extending from the first end of the sleeve to the second end of the sleeve. In other implementations, however, the sleeve may be substantially rectangular, triangular, flat or diamond-shaped, which means the walls of the sleeve may comprise, two, three, or even more flexible panels that are joined together during manufacture to form walls that completely surround and define the outer boundaries of the internal passageway.

Although it may be acceptable in some situations to make the flexible walls of the sleeve opaque, it has been found by the inventor that transparent or translucent flexible walls are typically more desirable because they permit a human user to see and monitor the condition and flow of the compound as it passes through the sleeve during discharge from the container. If the flexible walls of the sleeve are constructed from silicone, then the silicone is preferably molded to be about 1.8 mm thick, as this thickness provides sufficient amounts of strength, durability, puncture-resistance, elasticity and flexibility to the sleeve, as well as a sufficient amount of translucency for monitoring the flow of compounds therethrough. The human operator's ability to monitor the progress and integrity of the transfer operation may also be enhanced by placing one or more marks or other indicators (sometimes referred to as “witness lines”) on the outside of the sleeve to indicate proper placement of the compression clamp across the body of the sleeve for optimal performance of the overall system under various conditions. The sleeve may also include an access port configured to admit a rinsing solution to an interior portion of the sleeve to ensure, for example, that all of the compound is discharged from the containment and transfer system.

In order to support and strengthen the seal between the endcap and the second end of the sleeve, an annular groove is set into the sleeve-facing side of the endcap. This annular groove on the endcap is configured to receive and engage with an integral gasket ring protruding from the endcap-facing side of the second end of the sleeve. When the annular groove and the integral gasket ring are so engaged, and the endcap and the second end of the sleeve are fastened together with the second sanitary clamp, an airtight, hermetic seal is created between the endcap and the second end of the sleeve. In alternative configurations, the annular groove may be set into the endcap-facing side of the second end of the sleeve (instead of the endcap) and the integral gasket ring may protrude from the sleeve-facing side of the endcap (instead of the sleeve).

In one embodiment, the containment and transfer device of the present invention comprises the sleeve, the endcap for the sleeve, the compression clamp and the two sanitary rings for fastening the first end of the sleeve to a container (or other vessel) filled with the highly active or sensitive compound. Although this embodiment may be used with a container, the container itself is not a necessary component in this embodiment of the present invention. However, in other embodiments, the containment and transfer device of the present invention includes the container itself, as well as the sleeve, the endcap, the compression clamp and the two sanitary clamps. The container, which is portable, includes an interior chamber for storing the highly active or sensitive compound, a mouth (opening) for filling and discharging the compound, and a sanitary (i.e., non-threaded) fitting on the mouth. The container may be constructed from any one of a large variety of suitable materials, including without limitation, metal, polypropylene (PP), high-density polyethylene (HDPE), low-density polyethylene, phenol formaldehyde resin, glass, or a combination of two or more thereof. Typically, the portable container is made of a rigid material. But rigidity is not necessarily required. When the highly active or sensitive compound carried by the portable container requires sanitary, aseptic or sterile handling, the container is ideally constructed from a material that can withstand the means of sterilizing the container and transfer device (such as by autoclaving and/or gamma irradiation).

Ideally, the sanitary fitting on the mouth of the portable container also includes its own annular groove, set into the sleeve-facing side of the sanitary fitting, configured to receive and engage with an integral gasket ring protruding from the first end of the sleeve. Thus, when the sanitary fitting on the mouth of the portable container and the first end of the sleeve are fastened together with the first sanitary clamp, an airtight hermetic seal is created between the sanitary fitting and the first end of the sleeve. The hermetic seal prevents microbial ingress into the containment system, and also prevents leakage of the highly active or sensitive compound into the surrounding environment during packing, shipping and discharging of the containment system. Alternatively, the hermetic seal between the portable container and the first end of the sleeve may be achieved by placing the integral gasket ring on the sleeve-facing side of the sanitary fitting on the mouth of the portable container (instead of the sleeve), and setting the annular groove into the container-facing side of the first end of the sleeve (instead of on the sanitary fitting).

To further strengthen and support the seal between the first end of the sleeve and the sanitary fitting on the portable container, the first end of the sleeve and the sanitary fitting on the portable container may also include outward-facing perimeter flanges. These outward-facing perimeter flanges are configured to be received and held in place inside a corresponding inward-facing furrow on the first sanitary clamp when the first end of the sleeve and the sanitary fitting are fastened together with the first sanitary clamp. Ideally, the first end of the sleeve further includes a rigid support ring having a rigid support ring flange configured to abut and support the perimeter flange on the first end of the sleeve. When this is the case, the inward-facing furrow on the first sanitary clamp is further configured (i.e., made wide enough) to receive and hold the sleeve perimeter flange, the sanitary fitting perimeter flange, and the rigid support ring flange when the first end of the sleeve and the fitting are fastened together with the first sanitary clamp. Similarly, the second sanitary clamp used for fastening the second end of the sleeve to the endcap may also include an inward-facing furrow of sufficient width and depth to receive and hold the outer edge of the endcap, a second rigid support ring flange located on a second rigid support ring on the second end of the sleeve, and a second outward-facing perimeter flange extending from the second end of the sleeve. The rigid support rings and rigid support ring flanges on the first and second ends of the sleeve, which may be constructed, for example, from metal (such as stainless steel) or plastic, serve to reduce or eliminate deformation of the first and second ends of the sleeve when the flexible walls of the sleeve are deformed by the compression clamp.

While some implementations of the present invention involve attaching the sleeve to a portable container, such as a rigid bottle having internal chamber for storing the highly active or sensitive compound, other implementations utilize a double-ported flexible “bag,” instead of a sleeve, the bag having an internal reservoir for carrying or storing the highly active or sensitive compound. This double-ported flexible bag typically reduces, or altogether eliminates, the need for using a separate portable container to carry or store the highly active or sensitive compound. In accordance with this aspect of the invention, a containment and transfer device for use with a highly active or sensitive compound is provided, wherein the containment and transfer device comprises a flexible bag (or sack or pouch), a fill port endcap, a sanitary clamp and at least one compression clamp. The bag has a fill end, a charge end, and a reservoir located between the fill end and the charge end, and an internal passageway coupling the reservoir to the charge end of the bag. The reservoir is configured to hold the highly active or sensitive compound while the system is transported or used. The bag also has one or more flexible walls that circumscribe and define the internal passageway. Ideally, the flexible walls of the bag are constructed from an elastomeric and translucent material, such as silicone or low-density polyethylene (LDPE), although any suitable material may be used. The fill port endcap is configured to close the fill end of the bag. The sanitary clamp fastens the fill port endcap to the fill end of the bag. The compression clamp is fastened to the bag so that the one or more flexible walls of the bag are compressed together to form a barrier across the bag's internal passageway.

In one embodiment of the bag implementation of the present invention, if the bag is filled with a small-molecule gas, such as helium, then the barrier across the internal passageway of the bag will restrict the flow of the helium from the reservoir to the charge end of the bag to a flow rate of less than 1.0×10⁻³ cc/sec. In another embodiment, the barrier across the internal passageway of the bag will restrict the flow of the helium from the reservoir to the discharge end of the bag to a flow rate of less than 1.0×10⁻⁴ cc/sec. In still another embodiment, the barrier across the internal passageway of the bag will restrict the flow of the helium from the reservoir to the charge end of the bag to a flow rate of less than 1.0×10⁻⁵ cc/sec. And in yet another embodiment, the barrier across the internal passageway of the bag will not permit any molecules of the helium (or any molecules of a highly active or sensitive compound) to pass from the reservoir to the charge end of the bag.

Like the sleeve implementation, the compression clamp in the bag implementation of the present invention also comprises a pair of jaws, each jaw in the pair of jaws cooperating with the other jaw to apply uniaxial compression forces to the one or more flexible walls of the bag. The magnitudes of the uniaxial compression forces applied to the one or more flexible walls of the bag are substantially the same across the entire bite-length of the pair of jaws. The compression clamp further comprises one or more threaded rods configured to hold the pair of jaws together, each jaw in an opposing orientation to the other jaw, and one or more nuts that are operable with the threaded rods to uniformly adjust the magnitudes of the uniaxial compression forces applied to the flexible walls of the bag. Ideally, the nuts and threaded rods are tightened to a torque setting that is preferably in the range of about 5 to about 65 inch-pounds (or about 0.5649 to about 7.344 newton meters), more preferably in the range of about 20 to about 50 inch-pounds (or about 2.26 to about 5.649 newton meters), and most preferably about 35 inch-pounds (or about 3.954 newton meters).

Preferably, the bag implementation of the present invention also includes a charge port endcap configured to close the charge end of the bag, and a second sanitary clamp that fastens the charge port endcap to the charge end of the bag. The charge port endcap and the compression clamp are removed at the user site to permit the highly active or sensitive compound carried in the reservoir of the bag to pass freely through the internal passageway and out of the charge end of the bag into a storage or mixing container. Preferably, an access port is also provided near the fill end of the bag to facilitate rinsing the bag during or after the discharge operation.

### BRIEF DESCRIPTION OF THE FIGURES

The accompanying drawings, which are incorporated in and constitute part of the specification, illustrate preferred embodiments of the invention, and, together with the description, serve to explain the principles of the present invention.

FIGS. 1 through 5 show, from a number of different angles of view, an example of a containment and transfer device configured in accordance with one embodiment of the present invention.

FIG. 6 shows the exemplary containment and transfer device depicted in FIGS. 1-5, with the compression clamp component removed.

FIG. 7 shows an example of a container that might be used with embodiments of the present invention, the container configured to hold highly active or sensitive compounds.

FIGS. 8, 9 and 10 show, from a number of different angles of view, the exemplary containment and transfer device of FIGS. 1 through 5 connected to the exemplary container of FIG. 7.

FIG. 11 shows an exploded view of a containment and transfer device configured in accordance with the present invention.

FIGS. 12 and 13 show, by way of example, two different views of a compression clamp that might be used in an embodiment of the present invention.

FIGS. 14, 15 and 16 show, by way of example, several different views of a sleeve that could be used in an embodiment of the present invention.

FIG. 17 shows a close up view of the mouth and sanitary fitting on the container of FIG. 7, which could be used with one embodiment of the present invention.

FIGS. 18 and 19 show, from different angles of view, an endcap that could be used in one embodiment of the present invention.

FIG. 20 shows an example of a sanitary clamp that could be used in embodiments of the present invention.

FIGS. 21 and 22 illustrate how the sanitary clamp shown in FIG. 20 might be used, in accordance with some embodiments of the present invention, to releasably fasten the endcap to the second end of the sleeve.

FIGS. 23 and 24 show two different angles of view of a containment and transfer device configured in accordance with a second embodiment of the present invention, wherein a diamond shaped flexible bag having a reservoir for storing the highly active or sensitive compound is used instead of the sleeve.

FIGS. 25 and 26 show close up views of the compression clamp, barrier, charge end and charge port endcap components of the containment and transfer device depicted in FIGS. 23 and 24.

### DETAILED DESCRIPTION OF EXEMPLARY EMBODIMENTS

Exemplary devices according to certain embodiments of the present invention will now be described in more detail with reference to the accompanying figures. Although the exemplary devices shown in the figures illustrate embodiments of the present invention in which the sleeve is substantially cylindrical and has a substantially circular cross section, and the bag is substantially diamond-shaped, it is anticipated and understood that other embodiments of the invention (not shown in the figures) may have a variety of other geometric shapes, including without limitation, ellipses, triangles, rectangles, hour-glasses, and other shapes and forms suitable for storing or channeling solid, liquid or gaseous compounds and substances, as would be apparent to those of skill in the art upon reading this disclosure. Therefore, the figures and examples described below are not meant to limit in any way the scope of the present invention or its embodiments or equivalents to the shapes and forms depicted and described.

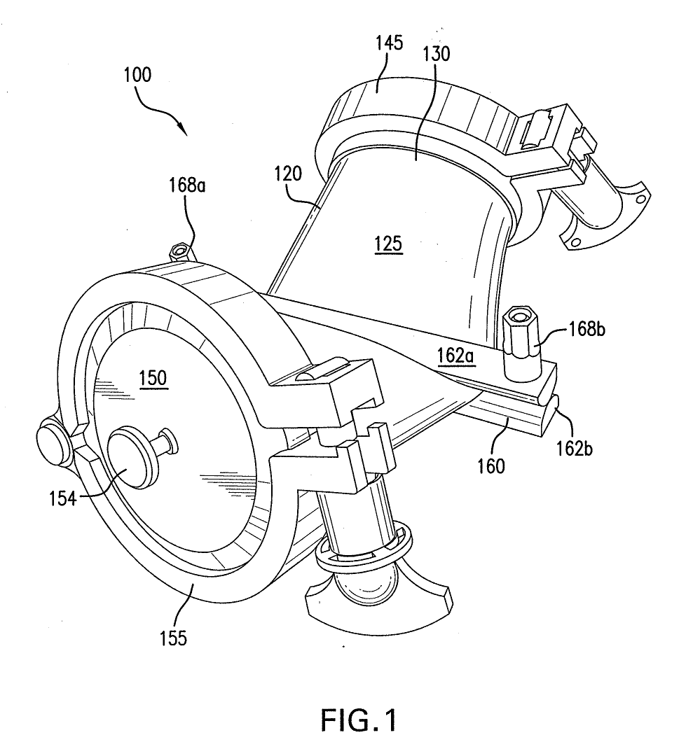

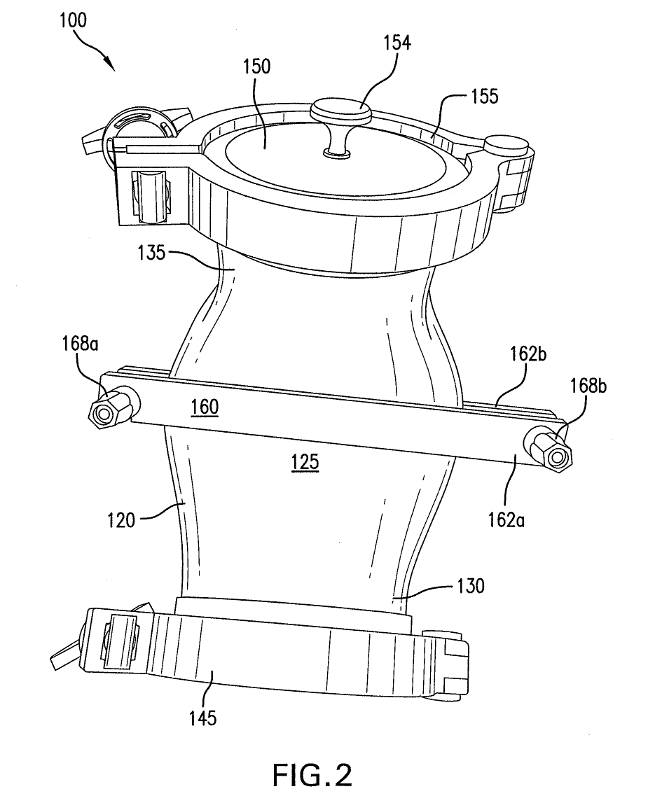

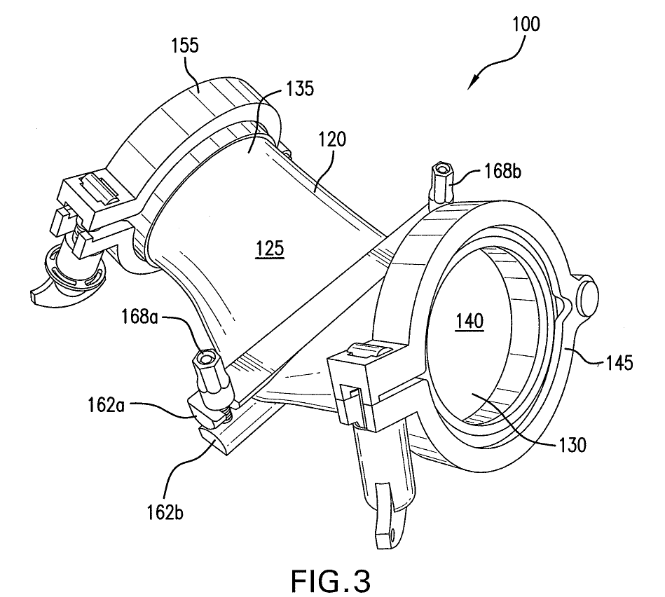

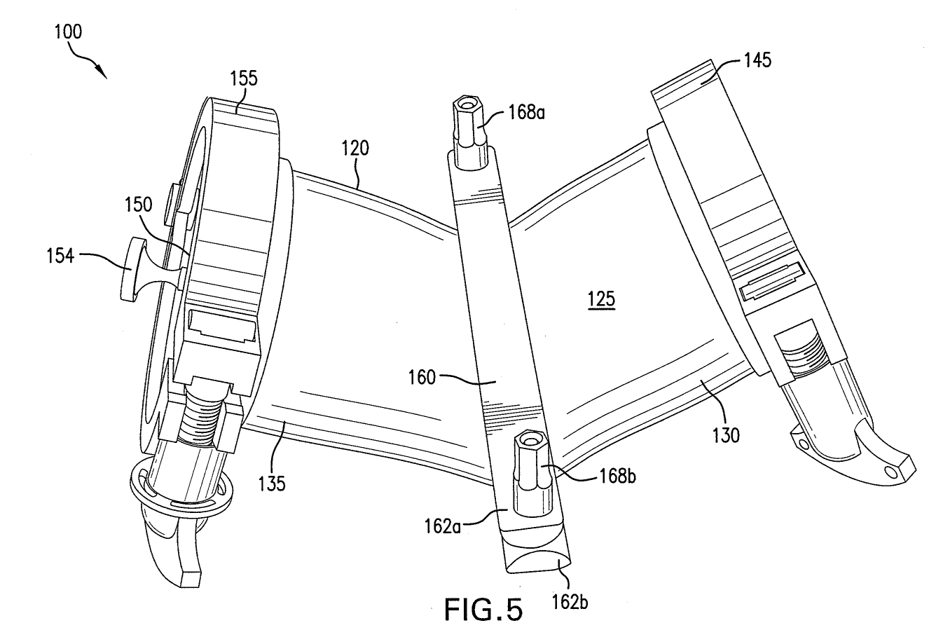

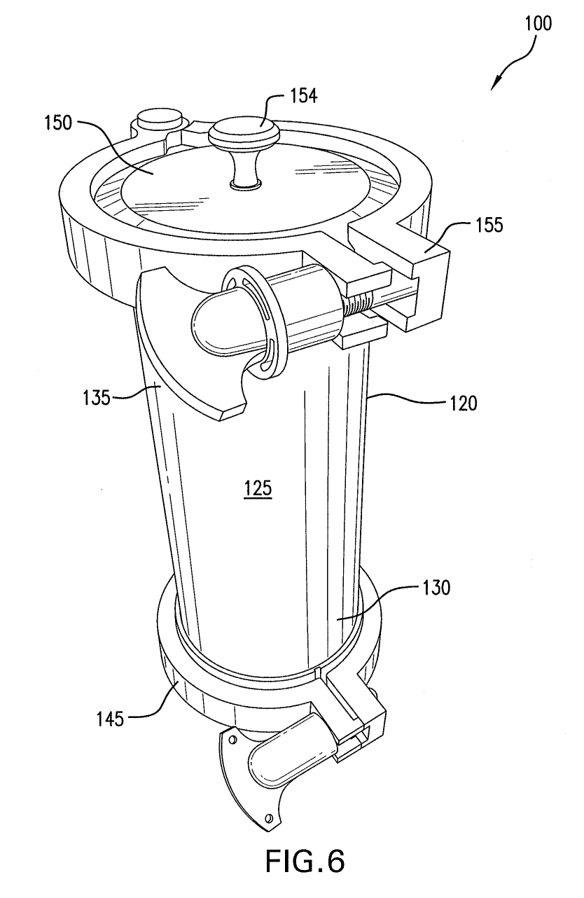

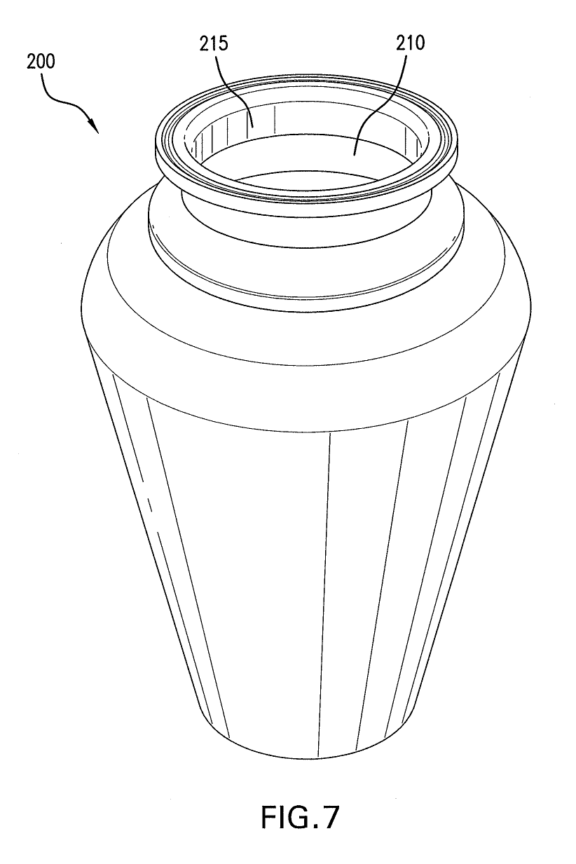

Turning now to the drawings, in which the same reference characters in multiple figures denote the same or similar elements throughout the several views, FIGS. 1 through 5 show, from a number of different angles of view, an example of a containment and transfer device 100 configured in accordance with one embodiment of the present invention. FIG. 6 shows the exemplary containment and transfer device 100, with the compression clamp 160 removed, and FIG. 7 shows an example of a container 200 that might be used with the containment and transfer device 100 shown in FIGS. 1 through 6.

As shown in FIGS. 1 through 5, the containment and transfer device 100 includes a sleeve 120, a first sanitary clamp 145, an endcap 150, a second sanitary clamp 155 and a compression clamp 160. The sleeve 120 has a first end 130 for connection to the container 200, a second end 135 for connection to a storage or mixing vessel (not shown in the figures) when the endcap 150 is removed at the discharge location, and a cylindrically shaped flexible wall 125 that surrounds and defines an internal passageway 140 that fluidly couples the first end 130 of the sleeve 120 to the second end 135 of the sleeve 120. The first sanitary clamp 145 is configured to releasably fasten the first end 130 of the sleeve 120 to a sanitary fitting 215 on the mouth 210 of the container 200 in FIG. 7. The second sanitary clamp 155 is configured to releasably fasten the second end 135 of the sleeve 120 to the endcap 155, which is suitably sized and shaped to plug and seal the second end 135 of the sleeve 120. Thus, the second sanitary clamp 155 and the endcap 150 cooperate to close and seal tight the second end 135 of the sleeve 120, and maintain this seal the entire time that the container 200 and the containment and transfer device 100 are being packed, transported and/or stored. The second sanitary clamp 155 is also used to connect the second end 135 of the sleeve 120 to a storage or mixing tank (not shown in the figures) when the endcap 150 is removed at the discharge location.

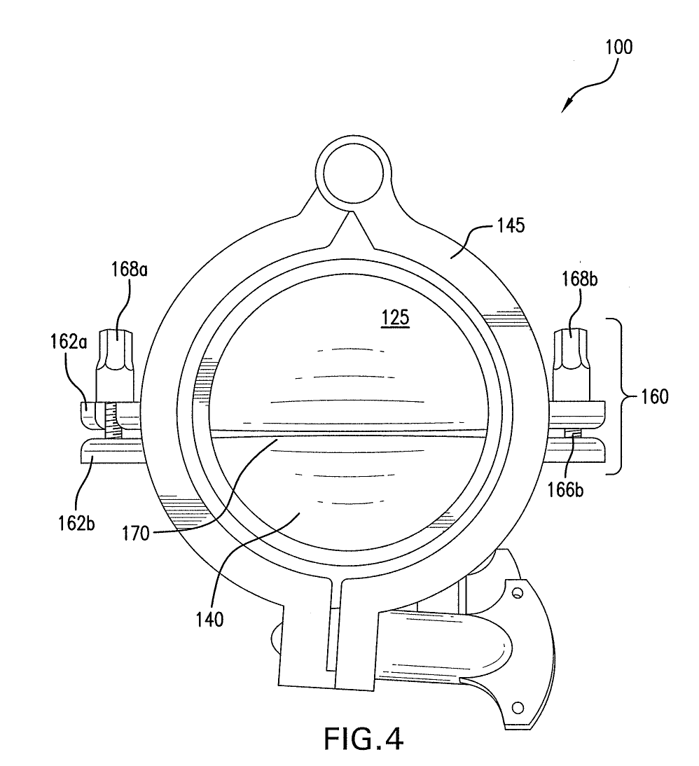

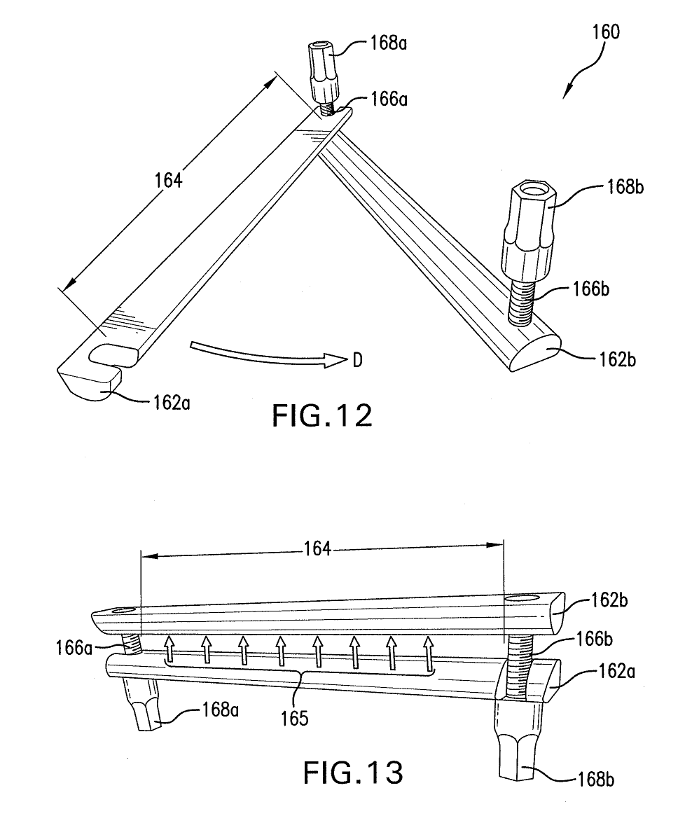

As shown in FIGS. 1 through 5, the compression clamp 160 has a pair of jaws 162a and 162b that are arranged to be uniformly compressed together by tightening the nuts 168a and 168b onto a pair of threaded rods 166a and 166b (shown best in FIGS. 12 and 13) extending from jaw 162b of the compression clamp 160. Prior to tightening the nuts 168a and 168b, the pair of jaws 162a and 162b of the compression clamp 160 are positioned on opposite sides of an intermediate section of the sleeve 120 so that, when the pair of nuts 168a and 168b are tightened, the pair of jaws 162a and 162b of the compression clamp 160 will move toward each other to compress the opposite sides of the flexible wall 125 of the sleeve 120 together in a substantially uniform manner. As shown best in FIG. 4, the compression on the opposite sides of the flexible wall 125 by the pair of jaws 162a and 162b causes the flexible wall 125 to impinge upon the internal passageway 140, which produces the barrier 170 in the internal passageway 140, effectively sealing off the internal passageway so that very little, if any, of the gases, solids or liquids in the first end 130 of the sleeve 120 can flow past the barrier 170 and into the second end 135 of the sleeve 120. The compression clamp 160 is designed to stay attached to the intermediate section of the sleeve 120 during handling, packing and transport of the container 200 and containment and transfer device 100. Optionally, the combined containment and transfer device 100 and container 200 may be inserted into one or more even larger containers (not shown), such as cooler, a footlocker or plastic bag, for added protection from moisture, pressure and temperature changes during transport.

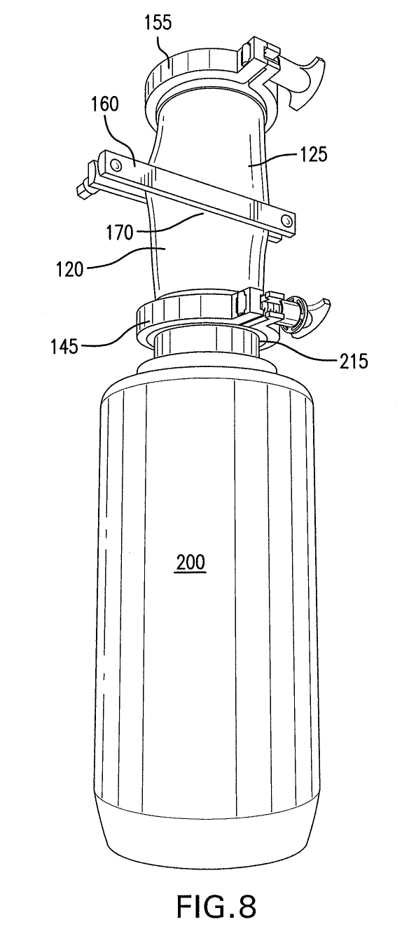

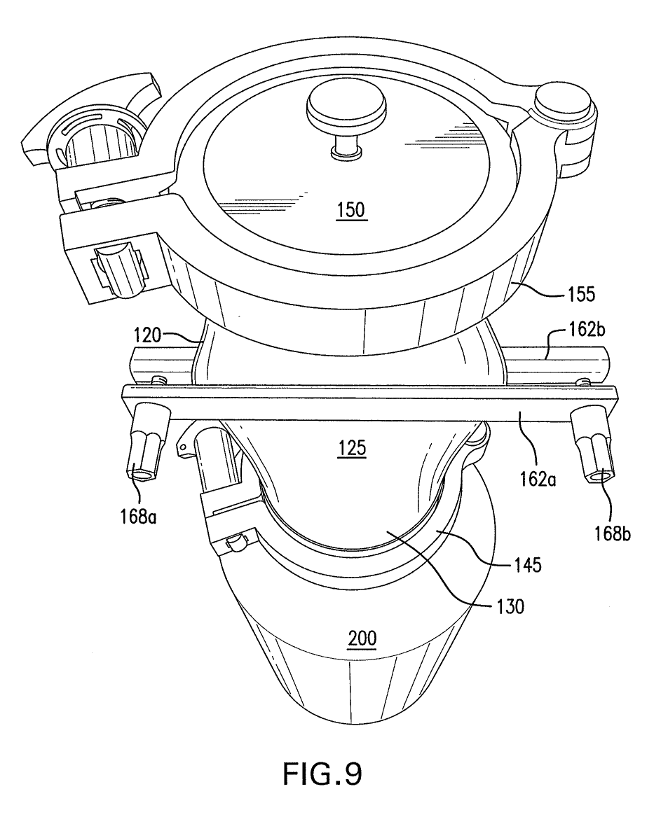

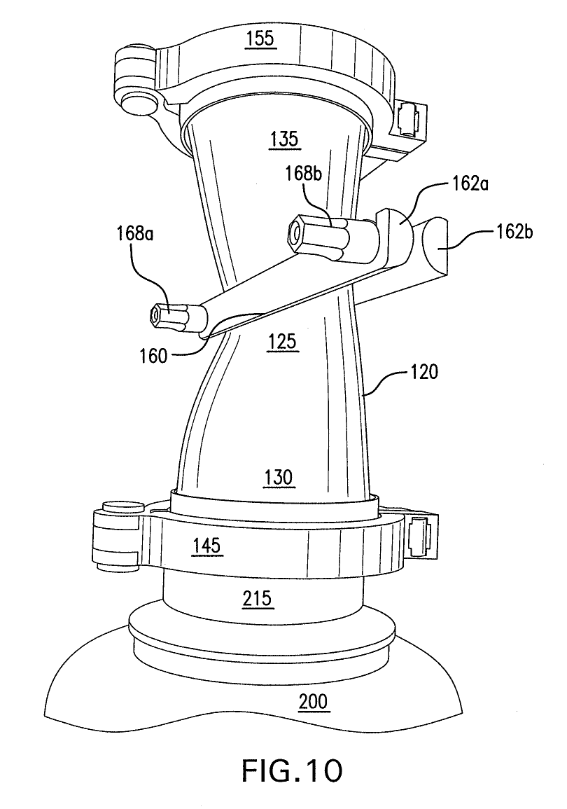

FIGS. 8 through 10 show, from a number of different angles of view, the exemplary containment and transfer device 100 of FIGS. 1 through 6 attached to the exemplary container 200 of FIG. 7. As shown in FIGS. 8-10, the first sanitary clamp 145 is sized and shaped to join the first end 130 of the sleeve 120 to the sanitary fitting 215 on the mouth 210 of the container 200. Notably, no cap or plug is required at the juncture between the container 200, the first end 130 of the sleeve 120 and the sanitary clamp 145 because the barrier 170 created by the compression clamp 160 attached to the sleeve 120 reduces or eliminates the flow of the highly active or sensitive compound into the second end 135 of the sleeve 120.

In one embodiment, the barrier 170 forms a hermetic seal that will not permit any portion of the highly active or sensitive compound (not shown in the figures) to pass from the first end 130 of the sleeve 120 into the second end 135 of the sleeve 120. Thus, the second end 135 of the sleeve 120 remains free of the highly active or sensitive compound—despite potential changes in altitude, temperature or pressure that may occur during packing or transport of the containment and transfer device 100 and container 200. In other embodiments of the invention, where, for example, a small amount of leaking can be tolerated, the compression clamp 160 and the resulting barrier 170 may be configured to eliminate the migration of all but an extremely small amount of the compound from the first end 130 of the sleeve 120 to the second end 135 of the sleeve 120, so long as the amount of compound permitted to migrate does not exceed a specified maximum rate or volume. For instance, in some implementations of the present invention, the barrier 170 across the internal passageway 140 limits the migration of the highly active or sensitive compound from the first end 130 of the sleeve 120 to the second end 135 of the sleeve 120 to a rate that is not greater than 1.0×10⁻³ cc/sec. In a more preferred embodiment, the barrier 170 across the internal passageway 140 restricts the rate of migration to no more than 1.0×10⁻⁴ cc/sec. In a most preferred embodiment, the barrier 170 across the internal passageway 140 limits the compound's flow from the first end 130 of the sleeve 120 to the second end 135 of the sleeve 120 to a rate of no more than 1.0×10⁻⁵ cc/sec.

The containment and transfer device 100 is designed to remain attached to the container 200 from the time that the container 200 is filled until it is time to discharge the container 200 at the destination user's site. When the container 200 and containment and transfer device 100 reach their final destination at the user site, the second sanitary clamp 155 and the endcap 150 are removed, without removing the compression clamp 160, to open the second end 135 of the sleeve 120. Although the second end 135 of the sleeve 120 is now open to the environment, there is no danger of contamination because the barrier 170 created by the jaws 162a and 162b of the compression clamp 160 prevent hazardous or sensitive material from entering the second end 135 of the sleeve 120. Next, the second end 135 of the sleeve 120 on the containment and transfer device 100 is attached to another vessel, such as a storage or mixing tank, or another sleeve or other conduit. If the highly active or sensitive material is a solid or liquid, then the container 200 and the containment and transfer device 100 are typically overturned during the discharge operation so that the force of gravity will assist in pouring the highly active or sensitive material out of the container 200, through the sleeve 120 and into the storage or mixing tank, or other conduit. Once that connection is made, the compression clamp 160 attached to the intermediate section of the sleeve 120 is removed, thereby eliminating the barrier 170 across the internal passageway 140 of the sleeve 120 and permitting the highly active or sensitive compound located in the first end 130 of the sleeve 120 and in the container 200 to pass through the internal passageway 140, through the second end 135 of the sleeve 120 and into the storage tank, mixing tank or conduit.

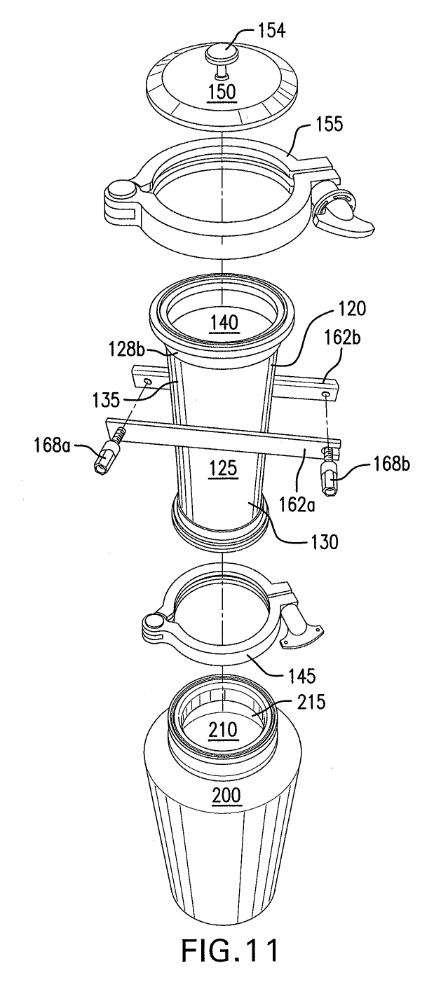

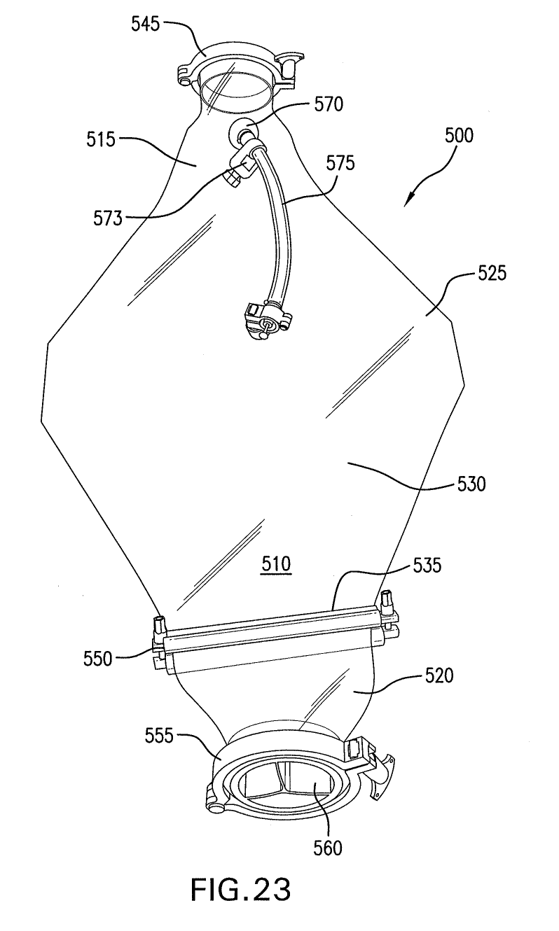

FIG. 11 shows an exploded view of the containment and transfer device 100 with the container 200. As shown in FIG. 11, the sanitary fitting 215 on the mouth 210 of the container 200 is attached to the first sanitary clamp 145. The first sanitary clamp 145 connects the sanitary fitting 215 to the first end 130 of the sleeve 120. The jaws 162a and 162b of the compression clamp 160 are positioned on either side of the flexible walls 125 of the sleeve 120 and compressed together by tightening the nuts 168a and 168b. The tightening of the jaws 162a and 162b constrict and close off the internal passageway 140 inside the sleeve 120. A second sanitary clamp 155 connects the second end 135 of the sleeve 120 to an endcap 150 with a handle 154. In preferred embodiments, a rinse tube with a valve (not shown in FIGS. 1-11) are attached to the flexible walls 125 of the sleeve to permit users to admit a rinsing agent to the internal passageway 140. One example of such a rinse tube and valve are shown in FIG. 23 (see rinse tube 575 and valve 573 in FIG. 23). Alternatively, a second sleeve (not shown) having a rinse adapter (also not shown) may be connected to the sleeve 120 and the container 200 so that the rinse adaptor in the second sleeve can be used to introduce and direct a sufficient amount of rinse agent to thoroughly remove any remaining residue of the highly active or sensitive material.

FIGS. 12 and 13 show two different views of the compression clamp 160. As shown in FIGS. 12 and 13, the compression clamp 160 comprises a pair of semi cylindrical jaws 162a and 162b connected to each other with a pair of threaded rods 166a and 166b and a corresponding pair of nuts 168a and 168b. The pair of jaws 162a and 162b have a bite-length 164 that is roughly equal to the distance between the pair of threaded rods 166a and 166b. The pair of jaws 162a and 162b, the pair of threaded rods 166a and 166b and the pair of nuts 168a and 168b are connected and arranged so that, when jaw 162a is engaged with the pair of threaded rods 166a and 166b (by swinging the jaw 162a in the direction D toward jaw 162b), and the pair of nuts 168a and 168b are tightened, the pair of jaws 162a and 162b will apply uniaxial compression forces 165 to any objects located between the pair of jaws 162a and 162b. In preferred embodiments, the magnitudes of the uniaxial compression forces 165 applied by the pair of jaws 162a and 162b are substantially uniform across the entire bite-length 164 of the pair of jaws 162a and 162b of the compression clamp 160. Uniformity in the magnitudes of the uniaxial compression forces exerted against the flexible wall 125 promotes a more dependable seal across the points of contact when the interior surfaces of the flexible wall 125 meet, especially if the highly active or sensitive compound comprises smaller molecules, as would be the case, for example, with helium.

Preferably, each nut in the pair of nuts 168a and 168b on the compression clamp 160 is tightened until the applied torque on each nut measures in the range of about 5 to about 65 inch-pounds (or about 0.5649 to about 7.344 newton meters). More preferably, each nut in the pair of nuts 168a and 168b is tightened until the applied torque on each nut is in the range of about 20 to about 50 inch-pounds (or about 2.26 to about 5.649 newton meters). The optimal torque value depends on the particular application where the device will be used, as well as the atomic structure of the compound. It has been observed by the inventor of the present invention that tightening the pair of nuts 168a and 168b to a torque of about 35 inch-pounds (or about 3.954 newton meters) is sufficient to ensure that helium molecules will not be able to pass through the barrier 170 at a rate greater than 1.0×10⁻⁵ cc/sec. As previously stated, certain embodiments of the present invention may instead call for applying the desired torque values to the pair of threaded rods 166a and 166b extended through a pair of nuts 168a and 168b that are configured to be locked in place and will not rotate. It will be appreciated by those skilled in the art that the compression clamp 160 may be constructed to have fewer or greater numbers of corresponding threaded rods and nuts, as well as a greater number of jaws, without departing from the scope of the present invention.

The compression clamp 160 may be constructed from any rigid material, such as hardened plastic, or metal (e.g., stainless steel). The inward-facing surfaces on each jaw in the pair of jaws 162a and 162b on the compression clamp 160 have a semi cylindrical shape to focus and increase the pressure between the inward-facing surfaces of the jaws on the compression clamp 160 and the outward-facing surfaces of flexible wall 125 on the sleeve 120, and thereby strengthen the effect of the barrier 170 created across the internal passageway 140 when the inward-facing surfaces of the pair of jaws 162a and 162b compress the opposite sides of the flexible wall 125 together.

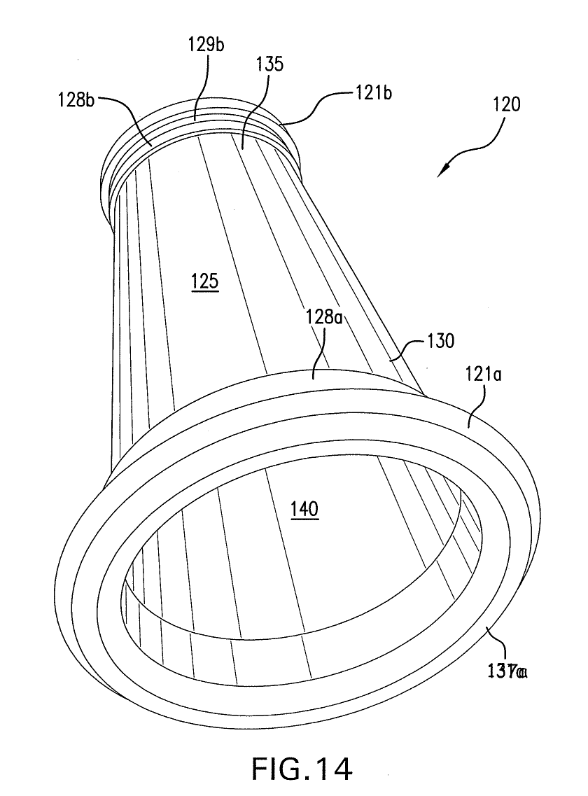

FIGS. 14, 15 and 16 show three different views of the sleeve 120. The sleeve may be constructed from any elastomeric material, such as silicone, butyl rubber, or any other natural or synthetic material capable of resuming its original shape when the deforming force of the jaws 162a and 162b of the compression clamp 160 is removed. In some implementations, the sleeve 120 is formed to be substantially cylindrical in shape, such that the cross section of the sleeve in its uncompressed state is substantially a circle. In this case, a continuous, cylindrically shaped and flexible wall 125 surrounds and defines an internal passageway 140 extending from the first end 130 of the sleeve 120 to the second end 135 of the sleeve 120. In other implementations, however, the sleeve 120 may be substantially rectangular, triangular, flat or diamond-shaped, which means the sleeve 120 could also have two, three, or more flexible panels comprising the walls, and these panels may be joined together during manufacture in such a way as to surround and define the outer boundaries of the internal passageway 140 between the first end 130 and the second end 135 of the sleeve 120. The internal passageway 140 may comprise any internal structures, of any shape or size, including the structures forming the inside surfaces of the flexible wall 125, that permits a compound located in the first end 130 of the sleeve 120 to flow into the second end 135 of the sleeve 120.

For the sleeve 120 shown in FIGS. 14, 15 and 16, the flexible wall 125 is substantially opaque. However, in some situations, it may be desirable or necessary to make the flexible wall 125 of the sleeve 120 translucent or transparent so that a user can easily see and monitor the condition and rate of flow of a compound as it passes through the sleeve 120 during filling and charging operations. If the flexible walls of the sleeve are constructed from silicone, then the silicone is preferably molded to be about 1.8 mm thick, which provides sufficient strength, durability, puncture-resistance, elasticity and flexibility for most filling, packing, shipping and discharging operations. A sleeve 120 made of silicone that is 1.8 mm thick is also translucent, which permits operators to more easily see and monitor the flow of compounds passing through the sleeve 120. Another advantage of silicone is that it is inert, relatively impervious to dramatic changes in temperature, and can be autoclaved or gamma irradiated without damaging the silicone. Ideally, one or more marks (not shown in the figures) are placed on the outside of the sleeve 120 to help the user determine the proper placement of the compression clamp 160 across the body of the sleeve 120 for optimal performance of the overall system under certain conditions. The optimal placement of the compression clamp 160 along the body of the sleeve 120 may vary, for instance, depending on headspace requirements, as well as anticipated changes in temperature and pressure associated with transporting the device and the compound to their final destination.

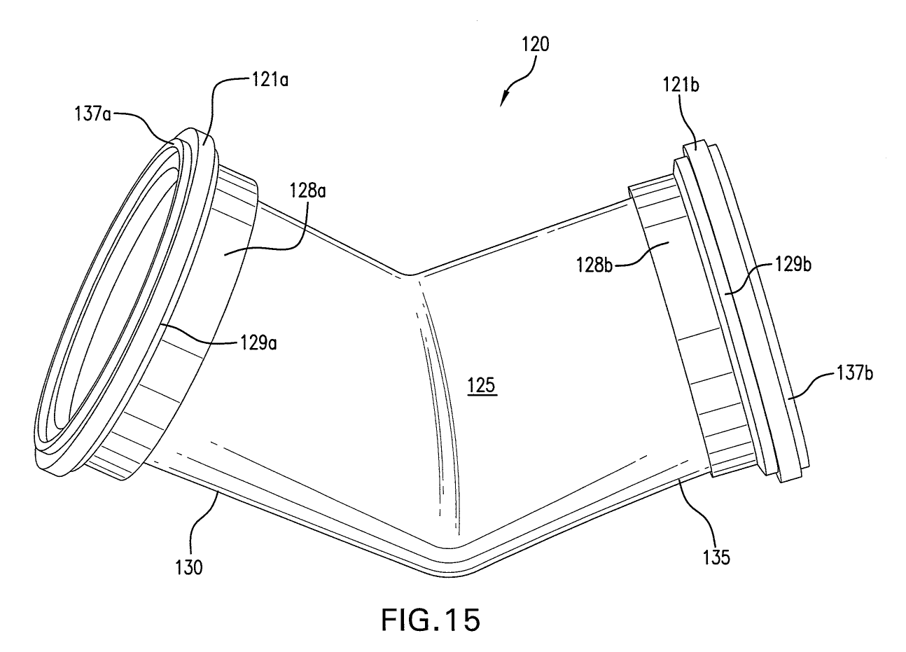

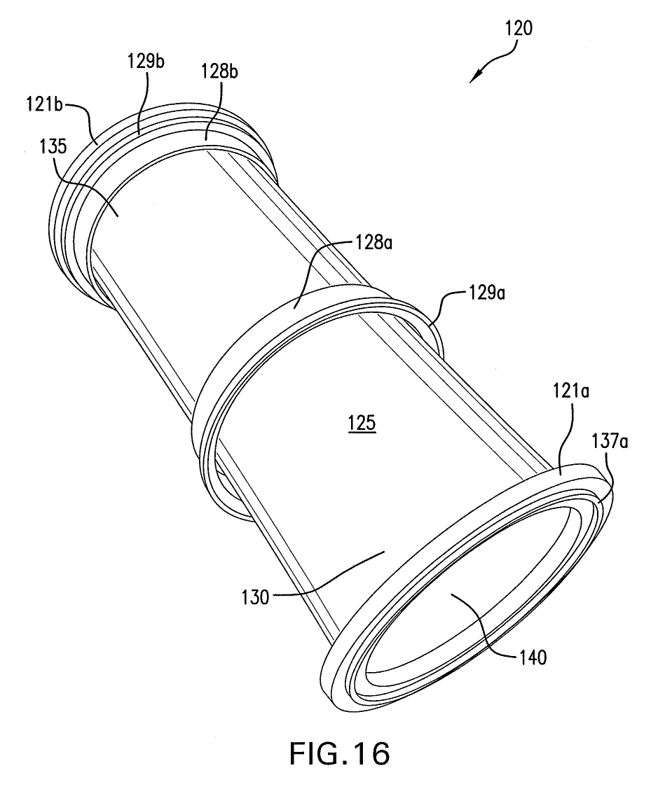

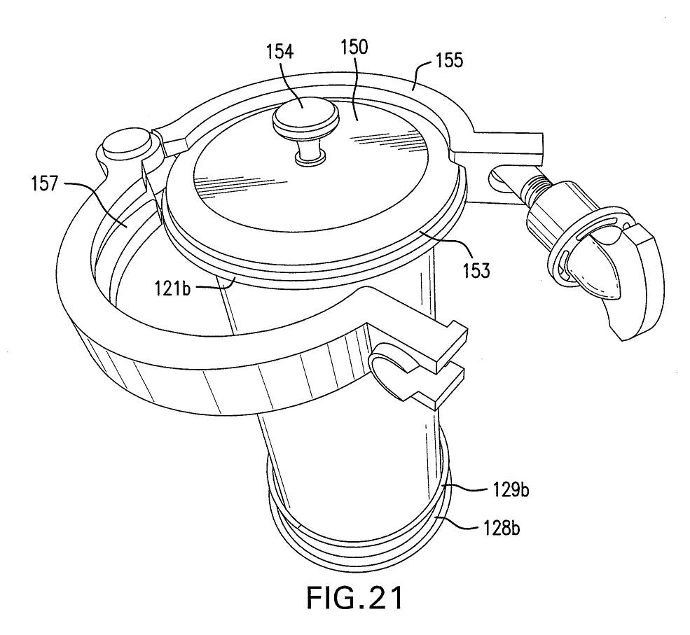

As shown in FIGS. 14, 15 and 16, an ideal sleeve 120 includes a pair of perimeter flanges 121a and 121b located at the first end 130 and the second end 135, respectively, of the sleeve 120. These perimeter flanges 121a and 121b, which extend radially outward from the major axis of the sleeve 120, are configured to fit within and engage inward-facing furrows on the sanitary clamps 145 and 155 used to attach the sleeve 120 to the container 200 and the endcap 150. See the inward-facing furrow 157 on the sanitary clamp 155 shown in FIGS. 20, 21 and 22. The ideal sleeve 120 also includes a pair of rigid external support rings 128a and 128b that, when moved into position at the first end 130 and the second end 135 of the sleeve 120, help to reduce or eliminate deformation of the first end 130 and the second end 135 of the sleeve 120 when the flexible wall 125 is deformed as shown in FIG. 15 by the operation of the compression clamp 160 (not shown in FIG. 15). As shown best in FIGS. 16 and 21, the rigid support rings 128a and 128b may be slidably attached to the sleeve 120.

Preferably, the rigid support rings 128a and 128b also include their own perimeter flanges 129a and 129b, respectively, configured to abut and support the engagement of the perimeter flanges 121a and 121b, respectively, on the sleeve 120 by the inward-facing furrows 157 of the sanitary clamps 145 and 144. Thus, the rigid support rings 128a and 128b, along with the rigid support ring flanges 129a and 129b, impart extra rigidity and stability to the first and second ends 130 and 135 of the sleeve 120, which facilitates making the connection between the sleeve 120 and the container 200, as well as making the connection between the sleeve 120 and the endcap 150. The extra rigidity also serves to ensure that these connections remain stable, airtight and secure, despite considerable deformation of the flexible wall 125 on the sleeve 120 resulting from application of the compression clamp 160. It will be appreciated by those skilled in the art that, although the rigid support rings 128a and 128b are shown in the figures as external, slidably attached components of the sleeve 120, alternative embodiments of the sleeve 120 may include rigid support rings that are integral to the sleeve 120 (e.g., fixedly molded into the ends of the sleeves). Moreover, the rigid support rings 128a and 128b may be eliminated in some embodiments of the present invention by making the perimeter flanges 121a and 121b on the sleeve 120 significantly thicker and wider than the examples shown in the figures. The sleeve 120 may also include one or more access ports (not shown) configured to permit users to attach hoses or tubes that allow the users to introduce other substances into the internal passageway 140 of the sleeve 120, including without limitation, wetting agents, surfactants, emulsifiers, foaming agents, dispersants, or rinses. Ideally, the access port includes a one-way valve configured to admit the rinsing solution without permitting any of the highly active or sensitive compound to escape into the surrounding environment.

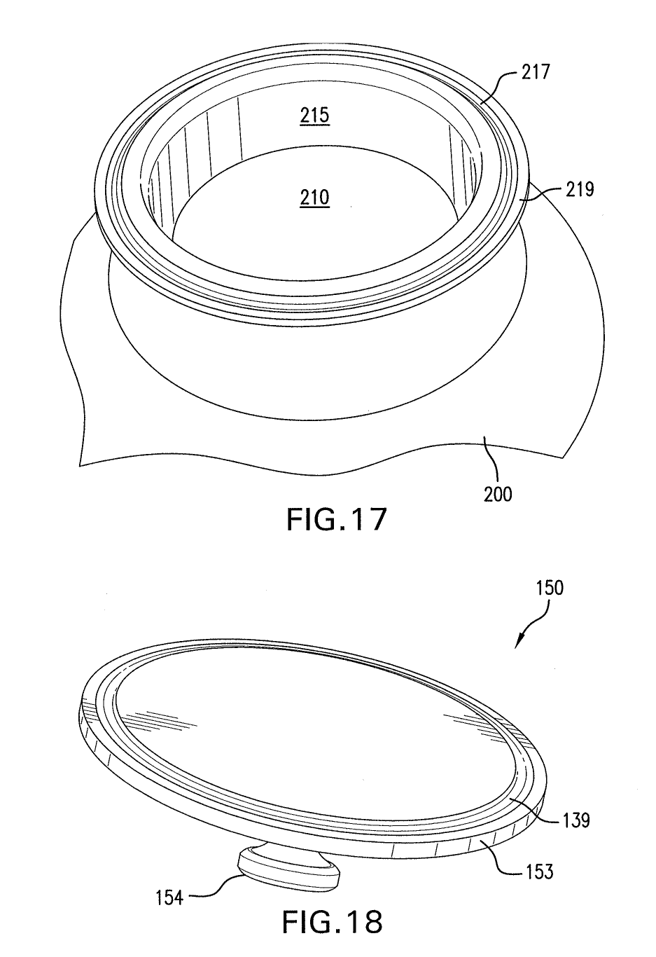

As shown best in FIGS. 14 and 16, the first end 130 of the sleeve 120 also includes an integral gasket ring 137a protruding perpendicularly from the perimeter flange 121a. The integral gasket ring 137a is configured to be received by and engaged with a corresponding annular groove 217 set into the sleeve-facing side of the sanitary fitting 215 on the mouth 210 of the container 200. The annular groove 217 set into the sleeve-facing side of the sanitary fitting 215 is shown best in FIG. 17. Similarly, the sleeve 120 also includes a second integral gasket ring 137b protruding perpendicularly from the other perimeter flange 121b on the second end 135 of the sleeve 120. The second integral gasket ring 137b is configured to be received by and engaged with a corresponding annular groove 139 set into the sleeve-facing side of the endcap 150. The annular groove 139 set into the sleeve-facing side of the endcap 150 is shown best in FIG. 18. In alternative embodiments, the annular grooves may be set into the container-facing side of the first end 130 of the sleeve 120 (instead of the container), and set into the endcap-facing side of the second end 135 of the sleeve 120 (instead of the endcap), in which case a pair of integral gasket rings would protrude from the sleeve-facing sides of the container 200 and the endcap 150.

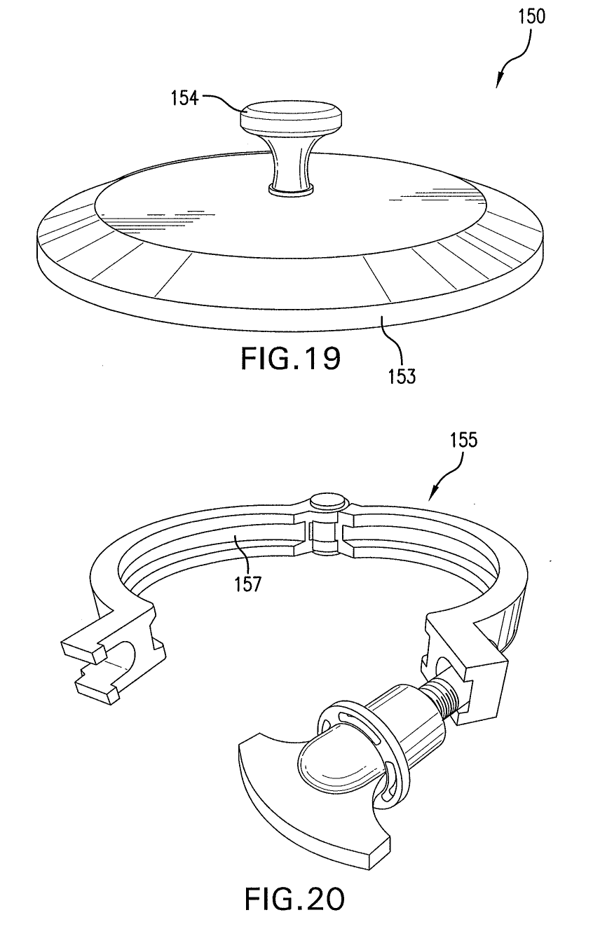

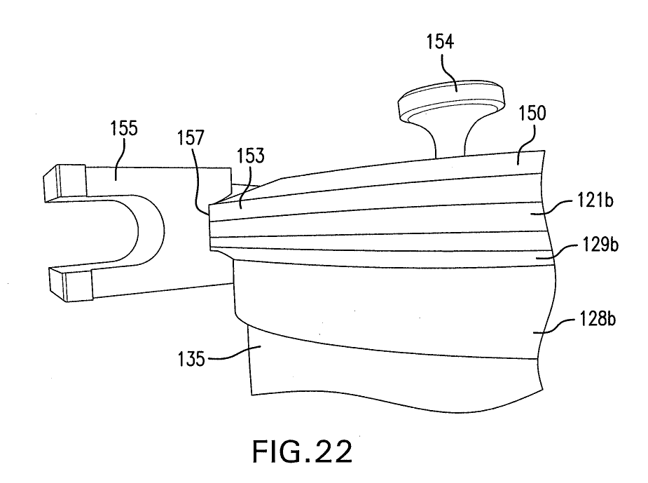

As shown best in FIG. 19, the endcap 150 ideally includes a handle 154, as well as a flat, rectilinear outer edge 153. In order to further support and strengthen the seal between the endcap 150 and the second end 135 of the sleeve 120, the second sanitary clamp 155 used to fasten the endcap 150 to the second end 135 of the sleeve 120 contains a deep, inward-facing furrow 157, which is shown best in FIG. 20. The deep, inward-facing furrow 157 is appropriately sized and oriented to receive and secure between its upper and lower teeth the outer edge 153 of the endcap 150, the perimeter flange 121b of the second end 135 of the sleeve 120, and the rigid support ring flange 129b on the rigid support ring 128b. See FIGS. 21 and 22. With the outer edge 153 of the endcap 150, the perimeter flange 121b of the sleeve 120 and the rigid support ring flange 129b all sandwiched tightly between the teeth of the inward-facing furrow 157 of the second sanitary clamp 155, as shown in FIG. 22, an airtight, hermetic seal is created between the endcap 150 and the second end 135 of the sleeve 120, which prevents any of the highly active or sensitive compound from escaping into the surrounding environment through this connection while the device is being packed and transported to the user site. A similar configuration and airtight hermetic seal is produced at the connection between the container 200 and the first end 130 of the sleeve 150, where the first sanitary clamp 145 also comprises a inward-facing furrow configured to receive and hold securely between its teeth another flange 219 extending radially from the sanitary fitting 217 of the container 200, the perimeter flange 121a of the sleeve 120, and the rigid support ring flange 129a on the rigid support ring 128a. In preferred embodiments, the first and second sanitary clamps 145 and 155 are constructed from solid, hardened nylon. However, other materials, including metal, may also be used, depending on the weight, rigidity, resistance to temperature changes, and impact strength requirements of the particular situation.

FIGS. 23 through 26 show an example of a containment and transfer device 500 configured in accordance with another embodiment of the present invention. As shown in FIG. 23, containment and transfer device 500 comprises a bag 525, a fill port endcap 540, a first sanitary clamp 545, and a compression clamp 550. The bag 525 has a fill end 515, a charge end 520, a reservoir 530 located between the fill end 515 and the charge end 520, the reservoir 530 configured to hold the highly active or sensitive compound (not shown). An internal passageway 535 fluidly couples the reservoir 530 to the charge end 520 of the bag 525. The bag 525 also has one or more flexible walls 510 that circumscribe and define the internal passageway 535. Ideally, the flexible walls 510 of the bag 525 are constructed from an elastomeric and translucent material, such as silicone or low-density polyethylene (LDPE), although any suitable material may be used. The fill port endcap 540 is configured to close the fill end 515 of the bag 525. The first sanitary clamp 545 fastens the fill port endcap 540 to the fill end 515 of the bag 525. The compression clamp 550 is fastened to the bag 525 so that the one or more flexible walls 510 of the bag 525 are compressed together to form a barrier 570 across the internal passageway 535 of the bag 525.

Because of the presence of the barrier 570 across the internal passageway 535 of the bag 525, the flow of the highly active or sensitive compound from the reservoir 530 into the charge end 520 of the bag 525 will be restricted to a flow rate of less than 1.0×10⁻³ cc/sec. In another embodiment, the barrier 570 across the internal passageway 535 of the bag will restrict the flow of the highly active or sensitive compound from the reservoir 530 to the charge end 520 of the bag 525 to a flow rate of less than 1.0×10⁻⁴ cc/sec. In still another embodiment, the barrier 570 across the internal passageway 535 of the bag 525 will restrict the flow of the highly active or sensitive compound from the reservoir 530 to the charge end 520 of the bag 525 to a flow rate of less than 1.0×10⁻⁵ cc/sec. And in at least one embodiment, the barrier 570 across the internal passageway 535 of the bag 525 will not permit any of the highly active or sensitive compound to pass into the charge end of the bag 525. The internal passageway 535 may comprise any internal structure, of any shape or size, including the structures forming the inside surfaces of the flexible wall 510, that permits a compound located in the fill end 515 of the bag 525 to flow into the charge end 520 of the bag 525.

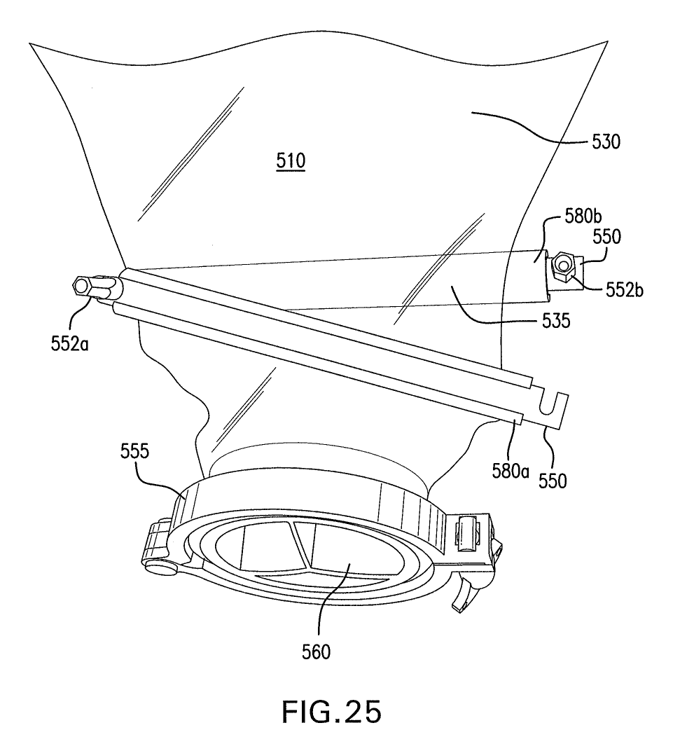

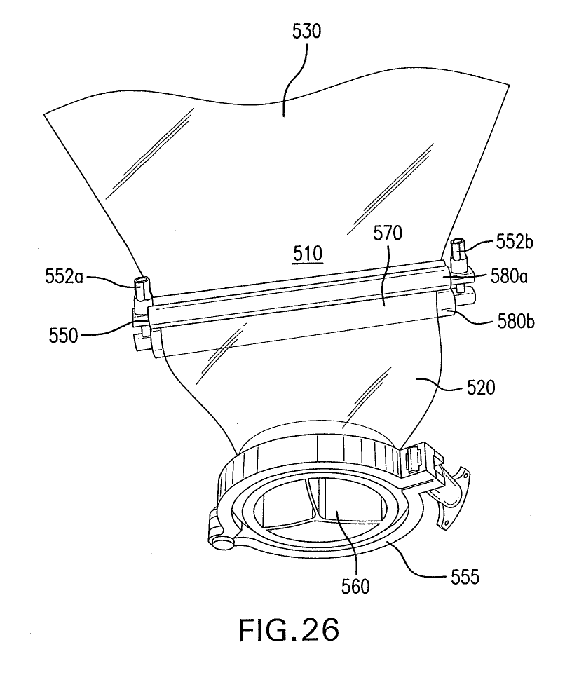

The compression clamp 550 comprises a pair of jaws cooperating with each other to apply uniaxial compression forces to the flexible walls 510 of the bag 525. The compression clamp 550 further comprises a pair of threaded rods configured to hold the pair of jaws together, each jaw in an opposing orientation to the other jaw, and a pair of nuts 552a and 552b that are operable with the threaded rods to uniformly adjust the magnitudes of the uniaxial compression forces applied to the flexible walls 510 of the bag 525. The pair of jaws on the compression clamp 550 have a bite-length roughly equivalent to the distance between the pair of nuts 552a and 552b on the compression clamp 550. The magnitudes of the uniaxial compression forces applied to the flexible walls 510 of the bag 525 are substantially the uniform across the entire bite-length of the pair of jaws. Ideally, the pair of nuts 552a and 552b are tightened to a torque setting that is preferably in the range of about 5 to about 65 inch-pounds (or about 0.5649 to about 7.344 newton meters), more preferably in the range of about 20 to about 50 inch-pounds (or about 2.26 to about 5.649 newton meters), and most preferably about 35 inch-pounds (or about 3.954 newton meters). As shown best in FIGS. 25 and 26, the pair of jaws of the compression clamp 560 may be covered with a elastomeric covers 580a and 580b (constructed, for example from silicone) to prevent damage to the flexible walls 510 of the bag 525 when the compression clamp 560 is fully compressed.

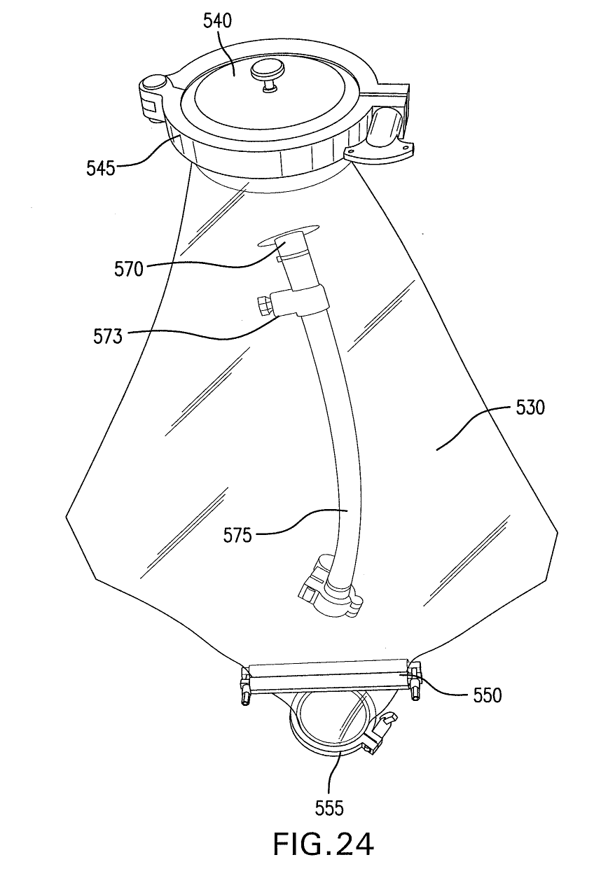

The containment and transfer device 500 also includes a charge port endcap 560 configured to close the charge end 520 of the bag 525 and a second sanitary clamp 555 that fastens the charge port endcap 560 to the charge end 520 of the bag 525. To empty the bag 525, the charge port endcap 560 and the compression clamp 550 are removed, which results in removal of the barrier 570 across the internal passageway 535. The removal of the barrier 570 from the internal passageway 535 permits the highly active or sensitive compound carried in the reservoir 530 of the bag 525 to pass through the internal passageway 535, out of the charge end 520 of the bag 525, and into a storage or mixing container (not shown in the figures). As shown best in FIGS. 23 and 24, containment and transfer device 500 may also include an access port 570 near the fill end 515 of the bag 525 to facilitate rinsing the bag 525 after the compound has been discharged. The access port 570 is ideally configured to attach a rinse tube 575 with a valve 573 operable to control the rate of flow of the rinsing agent.

The above-described preferred embodiments are intended to illustrate the principles of the invention, but not to limit its scope. Various other embodiments, modifications and equivalents to these preferred embodiments may occur to those skilled in the art upon reading the present disclosure or practicing the claimed invention. Such variations, modifications and equivalents are intended to come within the scope of the invention and the appended claims.

What is claimed is:

1. A containment and transfer device for use with a container and a highly active or sensitive compound, the container having a mouth and a sanitary fitting located at the mouth, the containment and transfer device comprising:
a) a sleeve comprising a first end, a second end, an internal passageway fluidly coupling the first end of the sleeve to the second end of the sleeve, and one or more flexible walls circumscribing the internal passageway;
b) a first sanitary clamp that fastens the first end of the sleeve to the sanitary fitting on the mouth of the container;
c) an endcap configured to close the second end of the sleeve;
d) a second sanitary clamp that fastens the second end of the sleeve to the endcap; and
e) a compression clamp that compresses the one or more flexible walls of the sleeve together to produce a barrier across the internal passageway.

2. The containment and transfer device of claim 1, wherein the barrier across the internal passageway will not permit the highly active or sensitive compound to pass from the first end of the sleeve to the second end of the sleeve at a rate that is greater than 0.001 cc/sec.

3. The containment and transfer device of claim 1, wherein the barrier across the internal passageway will not permit any portion of the highly active or sensitive compound to pass from the first end of the sleeve to the second end of the sleeve.

4. The containment and transfer device of claim 1, wherein:
f) the compression clamp comprises a pair of jaws having a bite-length;
g) each jaw in the pair of jaws cooperates with the other jaw to apply uniaxial compression forces to the one or more flexible walls of the sleeve; and
h) the magnitudes of the uniaxial compression forces applied to the one or more flexible walls of the sleeve are substantially the same across the entire bite-length.

5. The containment and transfer device of claim 4, wherein the compression clamp further comprises:
i) at least one threaded rod configured to hold the pair of jaws together, each jaw in an opposing orientation to the other jaw; and
j) at least one nut operable with the at least one threaded rod to uniformly adjust the magnitudes of the uniaxial compression forces applied to the one or more flexible walls of the sleeve.

6. The containment and transfer device of claim 5, wherein a torque in the range of about 5 to about 65 inch-pounds (about 0.5649 to about 7.344 newton meters) is applied to said at least one nut on the compression clamp.

7. The containment and transfer device of claim 5, wherein a torque in the range of about 20 to about 50 inch-pounds (about 2.26 to about 5.649 newton meters) is applied to said at least one nut on the compression clamp.

8. The containment and transfer device of claim 5, wherein a torque in of about 35 inch-pounds (about 3.954 newton meters) is applied to said at least one nut on the compression clamp.

9. The containment and transfer device of claim 4, wherein each jaw in the pair of jaws has a semi cylindrical shape.

10. The containment and transfer device of claim 4, wherein the compression clamp is constructed from metal or plastic.

11. The containment and transfer device of claim 1, wherein the one or more flexible walls of the sleeve are approximately 1.8 mm thick.

12. The containment and transfer device of claim 1, further comprising:
k) an integral gasket ring protruding from the endcap-facing side of the second end of the sleeve; and
l) an annular groove set into the sleeve-facing side of the endcap;
m) wherein the annular groove on the endcap is configured to receive and engage with the integral gasket ring protruding from the second end of the sleeve;
n) whereby a static seal is created between the endcap and the second end of the sleeve when the endcap and the second end of the sleeve are fastened together with the second sanitary clamp.

13. The containment and transfer device of claim 1, further comprising:
o) an integral gasket ring protruding from the sleeve-facing side of the endcap; and
p) an annular groove set into the endcap-facing side of the second end of the sleeve;
q) wherein the annular groove in the second end of the sleeve is configured to receive and engage with the integral gasket ring protruding from the endcap to create a static seal between the endcap and the second end of the sleeve when the endcap and the second end of the sleeve are fastened together with the second sanitary clamp.

14. The containment and transfer device of claim 1, further comprising an access port, connected to the sleeve, configured to admit a rinsing solution to an interior portion of the sleeve.

15. The containment and transfer device of claim 1, further comprising the container.

16. The containment and transfer device of claim 15, wherein the container is constructed from:
r) metal; or
s) polypropylene (PP); or
t) high-density polyethylene (HDPE); or
u) low-density polyethylene; or
v) phenol formaldehyde resin; or
w) glass; or
x) a combination of two or more thereof.

17. The containment and transfer device of claim 15, further comprising:
y) an integral gasket ring protruding from the container-facing side of the first end of the sleeve; and
z) an annular groove set into the sleeve-facing side of the sanitary fitting on the mouth of the container;
aa) wherein the annular groove on the sanitary fitting is configured to receive and engage with the integral gasket ring protruding from the first end of the sleeve;
bb) whereby, a static seal is created between the sanitary fitting and the first end of the sleeve when the sanitary fitting and the first end of the sleeve are fastened together with the first sanitary clamp.

18. The containment and transfer device of claim 15, further comprising:
cc) an integral gasket ring protruding from the sleeve-facing side of the sanitary fitting on the mouth of the container; and
dd) an annular groove set into the container-facing side of the first end of the sleeve;
ee) wherein the annular groove in the first end of the sleeve is configured to receive and engage with the integral gasket ring protruding from the sanitary fitting;
ff) whereby a static seal is created between the sanitary fitting and the first end of the sleeve when the sanitary fitting and the first end of the sleeve are fastened together with the first sanitary clamp.

19. The containment and transfer device of claim 15, wherein:
gg) the first end of the sleeve comprises a sleeve perimeter flange;
hh) the sanitary fitting on the container comprises a fitting perimeter flange; and
ii) the first sanitary clamp includes an inward-facing furrow configured to receive and hold both the sleeve perimeter flange and the fitting perimeter flange when the first end of the sleeve and the sanitary fitting are fastened together with the first sanitary clamp.

20. The containment and transfer device of claim 19, wherein:
jj) the first end of the sleeve further comprises a rigid support ring having a rigid support ring flange configured to abut and support the sleeve perimeter flange; and
kk) the inward-facing furrow in the first sanitary clamp is further configured to receive and hold the sleeve perimeter flange, the fitting perimeter flange, and the rigid support ring flange when the first end of the sleeve and the sanitary fitting are fastened together with the first sanitary clamp.

21. The containment and transfer device of claim 20, wherein the rigid support ring on the first end of the sleeve is constructed from metal or plastic.

22. The containment and transfer device of claim 1, wherein:
ll) the second end of the sleeve comprises a sleeve perimeter flange;
mm) the endcap comprises an endcap outer edge; and
nn) the second sanitary clamp includes an inward-facing furrow configured to receive and hold both the sleeve perimeter flange and the endcap outer edge when the second end of the sleeve and the endcap are fastened together with the second sanitary clamp.

23. The containment and transfer device of claim 22, wherein:
oo) the second end of the sleeve further comprises a rigid support ring having a rigid support ring flange configured to abut and support the sleeve perimeter flange; and
pp) the inward-facing furrow in the second sanitary clamp is further configured to receive and hold the sleeve perimeter flange, the endcap outer edge, and the rigid support ring flange when the second end of the sleeve and the endcap are fastened together with the second sanitary clamp.

24. The containment and transfer device of claim 23, wherein the rigid support ring on the second end of the sleeve is constructed from metal or plastic.

25. A containment and transfer device for use with a highly active or sensitive compound, comprising:
a) a bag comprising a fill end, a charge end, a reservoir located between the fill end and the charge end, the reservoir configured to hold the highly active or sensitive compound, an internal passageway coupling the reservoir to the charge end of the bag, and one or more flexible walls circumscribing the internal passageway;
b) a fill port endcap configured to close the fill end of the bag;
c) a first sanitary clamp that fastens the fill port endcap to the fill end of the bag; and
d) a compression clamp releasably fastened to the bag so that the one or more flexible walls of the bag are compressed together to form a barrier across the internal passageway;
e) wherein, the barrier across the internal passageway will not permit the highly active or sensitive compound held in the reservoir of the bag to pass into the charge end of the bag at a rate that is greater than 0.001 cc/sec.

26. The containment and transfer device of claim 1, wherein:
f) the compression clamp comprises a pair of jaws, the pair of jaws having a bite-length;
g) each jaw in the pair of jaws cooperates with the other jaw to apply uniaxial compression forces to the one or more flexible walls of the bag; and
h) the magnitudes of the uniaxial compression forces applied to the one or more flexible walls of the bag are substantially the same across the entire bite-length.

27. The containment and transfer device of claim 26, wherein the compression clamp further comprises:
i) at least one threaded rod configured to hold the pair of jaws together, each jaw in an opposing orientation to the other jaw; and
j) at least one nut operable with the at least one threaded rod to uniformly adjust the magnitudes of the uniaxial compression forces applied to the one or more flexible walls of the bag;
k) wherein a torque in the range of about 5 to about 65 inch-pounds is applied to tighten the at least one rod or the at least one nut.

28. The containment and transfer device of claim 27, further comprising:
l) a charge port endcap configured to close the charge end of the bag; and
m) a second sanitary clamp that fastens the charge port endcap to the charge end of the bag.
